(19) United States
(12) Patent Application Publication
(10) Pub. No.: US 2018/0126271 A1
(43) Pub. Date: May 10, 2018

(54) METHOD FOR DIRECTING PEOPLE IN A SPACE WHICH IS REPRESENTED BY A SPATIAL NETWORK, A WAYFINDING SYSTEM AND A GAME

(71) Applicant: Ran Katzir, London (GB)

(72) Inventor: Ran Katzir, London (GB)

(21) Appl. No.: 15/344,551

(22) Filed: Nov. 6, 2016

(51) Int. Cl. A63F 13/52; H04W 4/04; H04W 4/02; G06T 11/00; A63F 13/92; A63F 13/30

(52) U.S. Cl. CPC A63F 13/52; H04W 4/04; A63F 13/30; G06T 11/001; A63F 13/92; H04W 4/027

(57) ABSTRACT

A method for directing people in a space which is represented by a spatial network is disclosed. The spatial network is color-coded and movement is restricted to the space which this network represents. The method allows people to find paths and move in the space by matching a sequence of colors to the colors of graphical elements which they see in the space. Also disclosed are various methods and devices for a wayfinding system that helps people to orient themselves and navigate to various locations in a space. Finally disclosed is a game that allows random movement of playing tokens in a playing space where movement is restricted to a color-coded spatial network.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights rights whatsoever.

### TECHNICAL FIELD

The present invention relates generally to the fields of wayfinding and games. More particularly, to the fields of wayfinding and games taking place in spaces which are represented by spatial networks. Examples for such networks are transportation networks, indoor/outdoor pedestrian's networks, utility networks, telecommunication networks and spatial networks in games. However, other networks, which are not related to specific geographical area like social and biological networks, are relevant to this invention as well. People make movement in the space, either physically by themselves or logically by moving an icon, token or a symbol which represents them. Movement is restricted to nodes and links of the spatial network. As an example, in a transportation network, which permits vehicular movement, the nodes can represent road junctions, intersections, interchanges, airports, seaports, bus, tram and train stations and platforms. The links in a transportation network can represent roads, streets, train tracks, bus routes, airlines and ferry routes. Spatial paths are an alternating sequence of adjacent nodes and links along the spatial network and represent the respective path in the space. The invention may be particularly suitable for indoor/outdoor pedestrian wayfinding and playing as a board game, however, it is to be understood and appreciated that the methods, devices, systems and games may be used, presented, simulated and/or played in various other ways. For example, the method could also be used to navigate vehicles. The game can be played or presented as a video game, computer game, computer simulations, or online Internet game. Hence, the possible embodiments and/or applications of the invention as discussed below are given by way of example only.

### BACKGROUND OF THE INVENTION

People move along spatial networks everyday without realising it. When they drive their car, turn in junctions, walk in streets or ride the train. Navigation from place to place is a fundamental human activity and an integral part of everyday life. To find the way from their present location to desired destinations, people use maps, dead reckoning, compasses, signage, written directions, kiosks and GPS based navigation systems. These devices and methods orient people, guide them, and help them decide on the best way to travel. Taking into account many factors that can affect the journey.

A network is a collection of connected objects. We refer to the objects as nodes or vertices, and usually draw them as points. We refer to the connections between the nodes as links or edges, and usually draw them as lines between points. Links can be either undirected, or directed. If a link is directed we can refer to outbound directed links and inbound directed links and then draw them as arrows indicating the direction. If a link is undirected, it is both an inbound and an outbound link. A network map is a graphical representation of all or part of the network and illustrates the nodes and connecting links A network segment is a portion of the network and includes one or more nodes and one or more links of the network. Network adjacency matrix represents the availability and type of link between each node in the network. In some contexts, one may work with networks that have multiple links between the same pair of nodes. Network transition matrix specifies, for each originating node and it's outbound links, the target node that the outbound link leads to. A spatial network is a network in which the nodes or links are spatial elements that represent geometric objects, i.e. the nodes are located in a space equipped with a certain metric. Spatial paths are an alternating sequence of adjacent nodes and links along the spatial network, and represent the respective path in this space.

Wayfinding can be defined as a spatial problem solving. An effective method for wayfinding is usually one where each location has a unique identity, people don't have too many choices and involves only minimal relevant information and creates well-structured paths. Another factor, which can have a significant impact on path finding, is the use of color. Color acts as another variable in trying to distinguish between different signage types for example. People, at a very early age, develop the capability to distinguish between colors, and the use of colors in path finding is obvious to us and easy to see and appreciate.

### PRIOR ART DESCRIPTION

Vehicle drivers are used to get instructions like: “Turn left on the roundabout, third exit”, “Cross the roundabout, fifth exit”, “Turn left towards CityA, StreetC, Motorway5”, “In 1 Km turn left into 5th Avenue!”, “Keep left”, “Exit on the right”. These instructions refer to locations, distances, numbered exits and direction that are relative to the course of driving. Color is sometimes used in navigation systems to highlight the expected driving path, alternative routes and paths with heavy traffic. Drivers need to match the instructions they get with the signage system on the road, be able to read and understand the local language, count exists when they drive in roundabouts and make decisions fast. Most of the time these methods work, however often drivers make mistakes which can lead to accidents.

Pedestrians and visitors in buildings, airports, hospitals, museums, campuses, resorts or venues, are used to see signs with arrows and text in multiple languages and colors. These signage systems direct them to desired destinations in the respective structure. People expect to read signs and make decision quickly until they get to the destination they want. When they can't find it quickly enough or when they look for other source of information, the signs have failed. Signage systems have many limitations. If you put too many signs, it takes a long time to find the relevant one, if you put less, you are limited to the number of destinations you can direct to. Language barrier is also a problem for people who can't read and for people who don't know the local language. Multiple signs also create a visual clutter.

Sometimes maps with multiple continuous colored paths provide directions through interesting landmarks or attractions throughout the place. Usually there is some sort of indications where the person is located by using a large star symbol with other points of interest being drawn into the map. However, orientation is still a problem, as it's very difficult for a person to understand the person's orientation relative to the map and to derive directions accordingly. For Emergency and safety purposes, signage like “EXIT”, in red or green are used in every major exit to direct people to the nearest exit. Similarly, in airplanes, color strips on the floor direct passengers to the nearest emergency exists. Some train stations, hospitals and public spaces have limited number of color strips on the floor, which usually guide visitors through the entire place from one specific location to another specific location. There are many practical issues to this method for using lines which are glued to the floor. If you want to change the lines, it can be very difficult to take the lines up. Some travel hubs are stuck with lines which are now out of date and send you in the wrong direction. Moreover, there is a limit to the number of lines and continuous paths that you can place on the floor. For this reason, only very few common paths are used. Boats, parking lots, and hospitals might use different wall colors for different floors or areas to help passengers orient themselves and find their way quickly.

Train and bus networks are usually color-coded. Each train line or bus line has a unique distinguished color that identifies the line. Passengers switch trains in stations and use signage to walk from one train platform to the other. All stations are represented the same in the network map, usually as a black or white circle. This method is useful and effective, and helps pedestrians to make decisions quickly and to orient themselves underground. However Language barrier is still a problem for people who can't read and for people who don't know the local language as they need to read the station names, count stops, and understand which train or bus travels to which direction and from which platform.

Similarly, in various games and simulations, people travel along spatial networks. Only there, icons, tokens or symbols are used to represent the person. In some games, chance and rules can limit the movement. Players use dice, discs, spinner or playing cards to determine the distance or direction the player's tokens move in the playing space. The prior art known to Applicant in this area include several methods to handle movement: grid movement, point-to-point movement and area movement. On a playing area with point-to-point movement, there are certain spots that can be occupied by tokens, e.g. locations on a map or stopping points between locations. Single closed paths usually connect these spots, and movement is only possible along these lines. On a playing area with area movement, the game surface is divided into areas of varying size, and tokens can move out of or into in any direction as long as the areas are adjacent or connected. A grid map uses a uniform subdivision of the world into small regular shapes sometimes called “tiles” or “cells”. Common grids in use are square and hexagonal. Travel games use these methods to move the player's token about a geographical area using some sort of transportation means. Players can then learn about places, attractions, natural wonders and historical sites in the world or a city in an entertaining and interactive manner. Although in real life people mostly travel along networks, none of these game methods provide true random movement along one. A movement, which can lead from one location on the map to several random destinations, in one game turn, along a transportation network, is desired.

U.S. Pat. No. 9,152,975 issued to Covington; Nathaniel Kent on Oct. 6, 2015. Describes a wayfinding device that includes a stylized compass and a message element. The compass helps pedestrian to orient themselves along the streets but directs them only to the north.

U.S. Pat. No. 9,066,208 issued to Boyle, et al on Jun. 23, 2015. Provides a Method and system for wayfinding at a venue. The system is utilizing a mobile communication device, an app and plurality of sensors to navigate peoples in the venue.

U.S. Pat. No. 9,037,402 Issued to Simring; David Shapiro On May 19, 2015 Discloses systems and methods for programming directionally based textual instructions describing navigating to and from map locations along path segments between the locations. The textual instructions can then be arranged as output to a user in an order corresponding to a travel route to provide customizable textual instructions to a remote location that vary depending on the direction of the paths traversed in the route. Also disclosed are various methods and devices for delivering the textual instructions to an end user. The use of textual instructions is helpful, however it takes time to read the instructions, understand them, and then match them to the actual place.

U.S. Pat. No. 8,140,258 Issued to Dempsey; Michael on Mar. 20, 2012 discloses a device for giving directions to a desired destination within a building having a plurality of wayfinding beacons configured to transmit data using an ultrasound signal.

U.S. Pat. No. 6,646,545 Issued to Bligh; Maurice on Nov. 11, 2003. Discloses A battery powered, illuminated, color-coded evacuation signalling system embodying symbols and text messages in any language or combination of languages, configured by LED's in a network of floor laid display units installed in land-based buildings or maritime structures.

U.S. Pat. No. 1,538,134 issued to Charles S. Muir on May 19, 1925 discloses a Game simulating travel through the solar system and stars. Pure chance is used in determining the advancement of the playing tokens along a single path with stopping spots. No transportation network is involved and there is no use of color.

U.S. Pat. No. 2,128,608 issued to Clarence C. Goertemiller on Aug. 30, 1938 discloses a Game having a single convoluted path representing a route across the U.S., but the path does not truly resemble an actual route. Dice determine the distance the player moves, but only a single playing path is provided.

U.S. Pat. No. 2,268,433 issued to Mabel M. Smith on Dec. 30, 1941 discloses an Amusement Game using a geopolitical map of the United States as a playing board. The game simulates the buying, selling and railroad transport of various commodities during play, and depends primarily upon chance means for advancement. A spinner is used to determine distance and rules dictates direction.

U.S. Pat. No. 4,052,072, issued to Beal on October 1977, discloses an educational world map game adapted to be played on a pachisi-like game playing board bearing the world continental areas with countries marked off and lines of playing spaces traversed by playing pieces that are counted off according to the number on the roll of the dice and directed by drawn cards or playing pieces corresponding to continental areas.

U.S. Pat. No. 4,078,803 issued to Henry Te on Mar. 14, 1978 discloses a Board Game with Animal Tokens comprising a map of the world with multiple routes thereon. Each player receives a plurality of cards representing animals, with the object being to return these cards (animals) to the area of the board representing their native habitat. Tokens advance either forward or backward on the routes where the distance they travelled is determined by dice. No color-coding is used.

U.S. Pat. No. 4,082,284 issued to John N. Jennings on Apr. 4, 1978 discloses a Board Game Apparatus including a general outline of the U.S. with multiple playing paths thereon. The game involves simulated travel across the U.S. using the game board, but also involves the capture and escape of opponents' playing pieces. A die element indicates the distance to move the token.

U.S. Pat. No. 4,095,800, issued to Konsolas and published on June 1978 discloses a map board game apparatus having a map including a plurality of selected countries, each distinguishable from the others by the color thereof. A path is superimposed on the game board map and includes a plurality of stopping points in each country corresponding to the capital city of the country. A selector is included for effecting movement of the game members along the path and includes a base and a pointer rotatably mounted thereon wherein the base has an inter-radial band divided into the plurality of selectable segments, each having indicia thereon for instructing the movement of a game member a number of points along the path, and an outer radial band concentric with the inner band having indicia thereon associated with different countries for instructing the movement of game members to a stopping point in the country associated therewith. There is only one single path and no transportation network.

U.S. Pat. No. 4,368,889 issued to Louis M. Reker, Jr. on Jan. 18, 1983 discloses a Game Apparatus for Simulating School Experience in which multiple playing paths are provided, with the paths simulating a student's progress through school. As such, no geopolitical representation is provided, nor is any geographical knowledge required to excel in the play of the game. The number of squares the player moves correspond to the number indicated by the dice.

U.S. Pat. No. 4,784,394 issued to Vitaly Sumin on Nov. 15, 1988 discloses a Tourist Game Apparatus directed to a specific relatively localized area. The players move tokens about a map of the area using actual transportation schedules (i.e., bus, subway, etc.) as they attempt to “visit” designated tourist areas. A die with numbers is used to determine the distance the token moves at each turn.

U.S. Pat. No. 4,887,818 issued to Suzanne Escott on Dec. 19, 1989 discloses an Airline Ownership and Travel Game in which the simulated purchase of airlines and their routes is accomplished. No color is in use, and a number on a die indicate the distance each token moves on any turn.

U.S. Pat. No. 4,932,666 issued to Kenneth R. Corle on Jun. 12, 1990 discloses a Method for Playing a Travel Board Game comprising a geopolitical map of the U.S. with a generally rectangular peripheral playing path thereabout. Movement of the game pieces is along the rectangular and convoluted peripheral playing path, rather than across a network.

U.S. Pat. No. 5,813,671 to Barratt and published on September 1998 describes a board game that has at least one game path that is overlaid over a map of a geographical area, such as the northwestern United States. The players move their tokens along the game path and utilize activity cards that describe a vacation activity that can be performed at various locations along the game path to gain points. Trivia cards are also utilized to gain points. Dice with numbers are used to determine travel distance.

U.S. Pat. No. 4,928,967, issued to Woodliff and published on May 1990, discloses a map board game featuring an actual map of the world with an outer border in colors corresponding to the colors of specific regions. Players move from region to region around the world by traveling around the outer border or by choosing a transportation card, which allows for movement into certain regions. There is only one continuous path and no transportation network.

U.S. Pat. No. 4,961,582, issued to Van Lysel and published on October 1990, discloses a geographical travel game including a playing board with a large map of Western Europe bordered by 13 blocks that run along the bottom and left hand sides of the playing board. The playing map is divided into 16 European countries and 49 European cities. Players start from the bordering box and play proceeds into any city the player chooses. A die is used to determine distance.

U.S. Pat. No. 5,405,140 issued on Apr. 11, 1995 to Joyce A. Terlinden et al. Describes a Family Vacation Board Game including a geopolitical map of the United States with a plurality of separate playing paths there across. The object of the game is to answer geographical questions correctly in order to advance playing pieces along a round trip over the routes and back to the starting position. The game is thus a “race” type game, with the first player to reach the start/end position exactly, being the winner.

U.S. Pat. No. 6,019,370 issued on Feb. 1, 2000 to Morris Describes an Educational board game with one travel path. Players take turns attempting to advance along the travel path by correctly answering questions from a selection of questions and answers

U.S. Pat. No. 4,049,276 issued on Sep. 20, 1977 to Hole Describes a game board illustrating a map of the United States designating certain cities connected by color-coded airplane flight routes. An equal number of checkpoints on each flight route identifying the location of each flight at all times. A pair of numbered dice determines movement distance of aircrafts between checkpoints.

U.S. Pat. No. 4,988,108 issued on Jan. 29, 1991 to Shepard; Howard F. Describes a board game apparatus designed to guide and educate the players about geography. The separate locations are each distinguishable by a color and a number. A trail forms a closed loop around the map. The trail is divided into a plurality of spaces. Each space is also distinguishably colored and numbered to correspond to a separate location on the map. Players move their tokens along the trail according to a spinner. There is only one single path and no network.

British Patent No. 1,266,949 to Dennis E. Flynn and published on Mar. 15, 1972 discloses an Apparatus For Playing A Game in which a roulette wheel is used to determine the magnitude of moves over the board, but also requiring correct responses to questions posed in French from a “key-book”.

U.S. Pat. No. 4,097,051 issued on Jun. 27, 1978 To Goldberg; Robert M. Describes a board game showing a map of the world. The map is marked with latitude parallels and longitude meridians at small intervals, e.g., 10.degrees. The intersections forming a grid of spaces along which the playing pieces move. A pair of dice dictates the number of spaces the player moves along the latitude and longitude lines.

U.S. Pat. No. 4,070,026 issued on Jan. 24, 1978 to Cambardella; Nicholas A. Describes a game with a map of U.S. A grid of recesses is provided on the top surface of the game board which allows for the movement of game pieces there along. The grid of recesses is formed into a plurality of vertical rows and a plurality of horizontal rows, and the game pieces move there along a distance equal to a number shown by a first-game-piece control member, such as an eight-sided die.

U.S. Pat. No. 3,947,038 issued on Mar. 30, 1976 to Archer; Edward. Describes A map board game consists of a playing board having a map printed thereon, wherein a grid system consisting of squares is also printed on the playing surface. Spinner devices for moving in latitudinal and longitudinal directions on the map are provided, as well as a compass spinner device.

Finally U.S. Pat. No. 7,121,549 issued on Oct. 17, 2006 to Levine; Howard N. Describes a world geography and culture based game. The game board includes a map showing all the continents and two or more intersecting closed-loop paths. The paths are formed by individual spaces superimposed over the continents. Each player rolls the die in turn during the game to determine the number of spaces to move the playing piece.

### SUMMARY OF THE INVENTION

In view of the foregoing disadvantages inherent in the known wayfinding methods and games now present in the prior art, the general purpose of the present invention is to provide an improved and universal method for directing people in a space. It is one object of this invention to help people, of all ages, and from everywhere around the world, to navigate inside unfamiliar complex structures, to orient themselves, to improve their navigation decisions process, and to get to their target destination in the best and effective way. It is further object of this invention to improve the quality of games and to provide an experience that simulates real life behaviour where players randomly move along a complex network in the playing space. A modern term called playfinding is used to describe the convergence of wayfinding and play. The simplicity of this invention, and the visual elements described, will add to the overall fun and excitement of both wayfinding and games.

One aspect of the present invention is a method for directing people in a space which is represented by a spatial network. The network includes plurality of nodes, which represent geometric objects in the space, and plurality of links, which represent a different type of geometric objects in the space, which allow movement or flow between said geometric objects. A color, which is selected from a palette of two or more distinct colors, is assigned to every link and node in the network. Furthermore, the network has a unique characteristic that restricts every node to have no more than one outbound link for each color. A network transition matrix specifies for each originating node and color, the target node that the link with that color leads to from the originating node. As in every network, there can be several alternative paths that may lead from a source node to a destination node. Every spatial path is an alternating sequence of adjacent nodes and links and is represented by the respected sequence of colors of the nodes and/or links The geometric objects in the space are associated with colors using color-coded graphical elements having the color of the respective network element. Given a source node, a network transition matrix and an ordered sequence of colors, a spatial path can be devised, starting from the source node, by matching each color in the sequence to the colors of adjacent links and/or nodes as visible in the graphic elements. This process continues until no more colors are available in the sequence or when reaching the desired destination node. The method relies only on sequences of colors therefore it is universal for people of all ages and from everywhere around the world, it is clear, simple, consistent, and language independent, adaptable, scalable, concise, inexpensive, can work in the dark and in emergency situations, and suitable for all ages, from preschool children, to senior people. A non-limiting example system and game is specifically discussed and illustrated.

Another aspect of the present invention is a wayfinding system that helps people to get to desired destinations. In one embodiment, the system includes a mobile device and graphical objects which illustrate spatial network segments. The graphical objects are located in the space in a visible place, and present clearly the color of the node, and the color and general directions of possible outbound links which are connected to this node. The mobile device displays a sequence of colors to the user which directs the user in the space using the described method. In another embodiment, these graphical objects include illumination elements that can highlight specific graphical elements. A central control unit can then highlight entire paths across the space and direct a crowd of people to certain locations. This feature can be used in emergencies or to organize a big assembly. In yet another embodiment, these graphical objects include a wireless beacon which is used to improve the estimated position of the mobile device in the space. The mobile device can use this estimated position to display an indication during navigation or as a source node.

Yet another aspect of the present invention is a game. In one embodiment, the game includes a playing space which shows a map of predetermined geographical area. The playing space includes locations and transportation routes which form a color-coded network with color-coded nodes and links Each location on the map is represented by a playing card image which includes the location's name, photograph, country and “like” rating. The background color of the playing cards represents the type of the location. For example green background color might represent natural wonder, and yellow background color might represent historical sites. The color of the routes may represent either different transportation means such as cruise ships, trains, buses, airplanes, cars and trucks or same transportation means from different companies. The game uses the presented method for finding paths and movement to randomly move players along the network from one location to the other in every turn.

The game is unique because it utilizes a novel random movement along a color-coded network. This type of movement is simple to understand, unexpected and has no fixed path. Depending on the network transition matrix and the random outcome, players can move, in a single turn, from one side of the map to many different possible destinations on the other side of it. It may seem complex to perform, but due to the visual nature of the graph, even younger players can find valid paths in seconds. Furthermore, the game is unique because the map, the transportation network, the dice, playing tokens, locations, general knowledge questions and “like” tokens all rely on distinct visual content which is also suitable for preschool children.

This summary is provided to introduce a selection of concepts in a simplified form that are described in further detail in the detailed description and drawings contained herein. This summary is not intended to identify key features or essential features of the claimed subject matter, nor is it intended to be used as an aid in determining the scope of the claimed subject matter. Yet other forms, embodiments, objects, advantages, benefits, features, and aspects of the present invention will become apparent from the detailed description and drawings contained herein.

### Terminology

The following terms, as used throughout the specification and claims, have the associated, non-limiting, meaning:

A network: a collection of connected objects.

A node or a vertex of a network: one of the objects in the network that are connected together.

A link or an edge of a network: one of the connections between the nodes.

A directed link: a link that points from one node to the next.

An outbound link of a node: a directed link that points away from that node to another node.

An inbound link of a node: a directed link that points to that node from another node.

An undirected link: a bidirectional link which is both an outbound link and an inbound link and points both ways

Network elements: links and nodes of the network.

A network map: a graphical representation of all or part of the network.

A network segment: a portion of the network that includes one or more nodes and links of the network.

A network adjacency matrix: specifies the availability and type of link between each node in the network.

A network transition matrix: specifies for each originating node and its outbound links the target node that the outbound link leads to. The matrix can further include titles, descriptions, locations, ids or functions of the nodes and/or links.

A color-based network transition matrix: A network transition matrix where colors determine the transition.

A network path: an alternating sequence of adjacent nodes and links between two nodes in the network. The network path must respect the direction of links.

A space: any 2D or 3D space equipped with a certain metric. Can be physical, holographic, simulated, virtual, projected, or displayed space.

A geometric object: an object in a space.

A spatial network: a network in which the nodes or links are spatial elements that represent geometric objects.

A spatial network path: a network path which represent a respective path in the space.

A color or colors: a visual property which is not restricted just to chromatic colors. Any combination of chromatic, achromatic, illuminated, light reflecting, solid, patterned, textured or shaded color is relevant to this invention.

Similar colors: two colors which to the eye of a typical person would look the same.

A palette of visually distinct colors: a set of two or more colors where no two colors in the set are similar.

A mobile device: a personal mobile device that includes a color user interface, a communication interface and can run software applications. Relevant devices are smart phones, tablets, smart watches, laptops, personal navigation devices, vehicle navigation devices or any other wearable computing device.

A computer: any computer, static or mobile, personal, public, commercial or kiosk, stand alone or connected to a network, as long as the computer is capable of receiving information (data) in a particular form and of performing a sequence of operations.

A wireless beacon: wireless beacons which use any form of wireless communication and protocols such as RF signals, sound, ultrasound, light, laser, Bluetooth, Wi-Fi, RFID.

Graphic design: a visual representation of ideas and messages that is formed from a combination of symbols, images and text. Can be printed, projected, joined, adhered, painted on any surface or displayed on screens, LCDs or led arrays.

An illumination element: any form of light emitting devices such as LED, lamps, laser in different colors.

A playing space: a hard planar surface such as a typical board game or gaming mat, three dimensional surfaces such as three dimensional sphere or three dimensional topography of an area and also a computer screen or a projection.

A playing token: a tangible or physical token or a computer-generated icon, symbol or indicator.

A playing card: a tangible card or physical cards and computer-generated images of a card.

### BRIEF DESCRIPTION OF THE DRAWINGS

FIG. 1 illustrates a map of an example space. An embodiment of a graphical object is illustrated in every major room of the museum.

FIG. 2 illustrates a network map of a spatial network, which represents the example space of FIG. 1.

FIG. 3 is a table, which describes the network transition matrix for the spatial network illustrated in FIG. 2.

FIG. 4 and FIG. 5 illustrate examples of embodiment of a graphical object located in the rooms of the space of FIG. 1.

FIG. 6 and FIG. 7 and FIG. 8 and FIG. 9 illustrate further examples of embodiment of the graphical object.

FIG. 10 illustrates one embodiment for displaying a sequence of colors, on the display of a mobile device.

FIG. 11 illustrates another embodiment for displaying a sequence of colors, printed on a paper.

FIG. 12 illustrates the map of FIG. 1 with another embodiment of graphical objects.

FIG. 13 illustrates further example space, which is a playing space with a map of the world.

FIG. 14 is a table that describes the network transition matrix for the spatial network illustrated in FIG. 13.

FIG. 15 is schematic representations of three color-coded dice, which is one option to generate a random sequence of colors.

FIG. 16 is a top plan view of a location card that is utilized with embodiment of the game of the present invention.

FIG. 17 is a top plan view of a variety of “like” tokens, which are utilized, with the game of the present invention.

FIG. 18 is a perspective view of a miniature jet airplane, which is an example of a playing token that can be utilized with the game of the present invention.

FIG. 19 and FIG. 20 illustrate one embodiment of a general knowledge question that can be utilized with the game of the present invention.

### DETAILED DESCRIPTION OF THE OF A PREFERRED EMBODIMENT

Before describing the invention in detail, it must be stated that the enclosed figures and drawings are merely illustrative of a preferred embodiment and represent one of several different ways of configuring the present invention. Although specific components, designs, colors, locations, methods, devices, configurations and uses are illustrated, it should be understood that a number of variations to the components and to the configuration of those components described herein and in the accompanying figures can be made without changing the scope and function of the invention set forth herein.

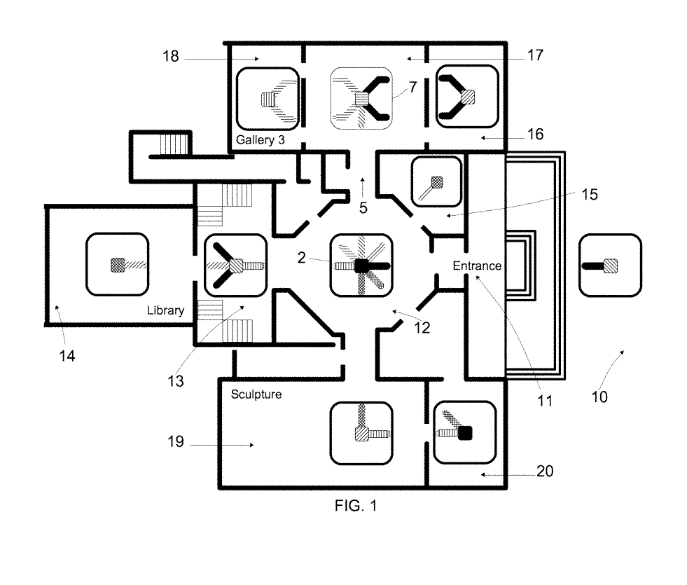

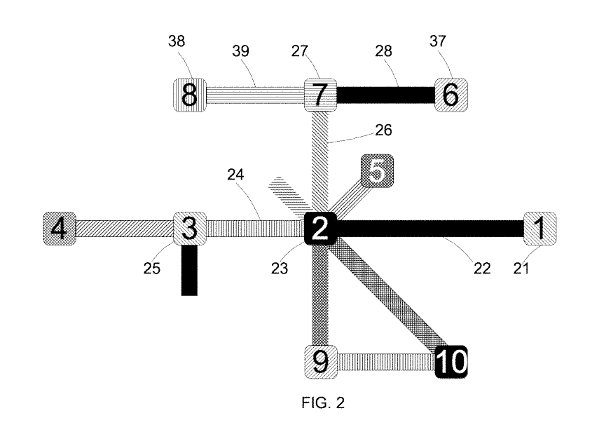

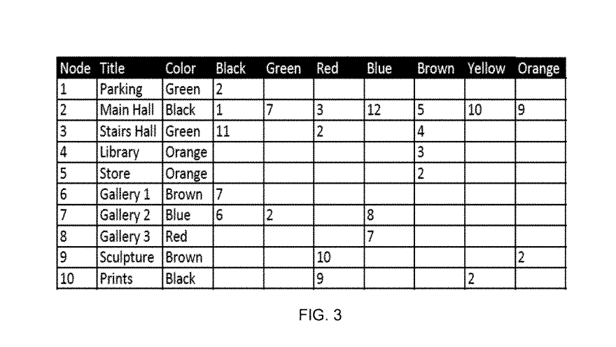

Referring now to the invention in more detail, in FIG. 1, there is illustrated in, a schematic format, the map of the first floor of a museum which serves as a simple example for a space where people move and navigate. People enter the museum from the parking 10 through the main entrance 11 until they reach the main hall 12. As described in the table in FIG. 3, the museum has six galleries: Gallery1 16, Gallery2 17, Gallery3 18, a sculpture room 19, a print room 20 and a library 14. The museum also has a store 15 and a stair hall 13. The rooms, halls, doors and the stairs in the museum are geometric objects and form an indoor spatial network. Rooms and halls are represented by nodes, and corridors, doors, and entrances, which connect between the rooms and the halls, are represented by links. All the links are undirected and allow movement of people in both ways. The parking 10 is also a geometric object and represented by a node 21, but is part of a different adjacent road network. The described network does not represent some areas in the museum because they are less important for this example. Referring now to the network map illustrated in FIG. 2, the map shows all the nodes and links in the network. Node1 21 in the table represents the parking 10, Node2 23 represents the main hall 12, Node3 25 represents the stair hall 13. Nodes in the map have a square shape and links are illustrated as thick lines between the squares. For example, Node1 21 is connected to Node2 23 through link 22. Node2 23 is connected to Node7 27 through link 26.

Referring now back to the network transition matrix in FIG. 3, a palette of two or more visually distinct colors was chosen and a color from the palette was assigned to every network element. The palette includes seven colors: black, green, red, blue, brown, yellow and orange. Those skilled in the art will appreciate that the palette may include any combination of solid, illuminated, light reflecting, patterned, textured or shaded color as long as they are visually distinct for people. The network transition matrix describes the id, title and color of every node, and specifies for every node and outbound link color, the target node of the outbound link. If there is no outbound link for this node and color, there will be an empty value in the respective place. Looking at the matrix, it's clear that for every node and color there is no more than one outbound link. For example: Node7 27, in the table, which has a blue color and represents Gallery2 17, has three outbound links: a black link 28, which represents the doors between Gallery2 17 and Gallery1 16, and is connected to Node6 37, which represents Gallery1 16; a green link 26, which represents the passage between Gallery2 17 and the main hall 12, and is connected to Node2 23, which represent the main hall 12; and a blue link 39, which represents the doors between Gallery2 17 and Gallery3 18, and is connected to Node8 38, which represents Gallery3 18.

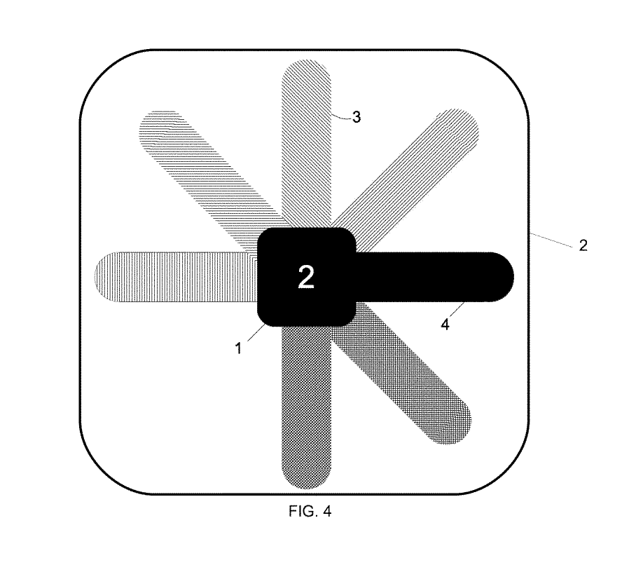

The preferred embodiment of a graphical object is illustrated in FIG. 4 in a schematic format. The graphical object 2 includes 8 graphical elements in the centre, and is embedded on the surface of the floor of the main hall 12 where people can see it. The design and position of each graphical element, as placed on the floor in main hall 12, indicate, to the people who are in the room, a certain geometric object. Furthermore the graphical element is color-coded with the color of the network element which represents the indicated geometric object. These visual communication techniques create association between the network element color and the geometric object. As an example, in FIG. 1, the green graphical element 3 in graphical object 2 is designed to point toward passage 5 between the main hall 12 and Gallery7. It is also positioned on the top area of the graphical object 2. These two design techniques associate it with the passage 5 between the main hall 12 and Gallery7. Passage 5 is represented by link 26, which is green as well. The black graphical element 1 in graphical object 2 is located in the centre of graphical object 2, which associate it with the main hall 12. The main hall 12 is represented by Node2 23 which is black as well. Association between geometric objects and colors is a known technique to communicate some kind of message or idea which is related to the geometric object. The present invention uses this association method for navigation purposes. However there can be further advantages to this association that can be exploited. Those skilled in the art will appreciate that there can be many possible ways to design and stylize the graphical object, and a number of variations can be made without changing it's function. Furthermore, there are many visible places and methods to embed the graphical objects to the surface of the geometric objects. They can be glued to the floor, painted on the wall, attached to the ceiling and walls in many configurations and variations without affection their use.

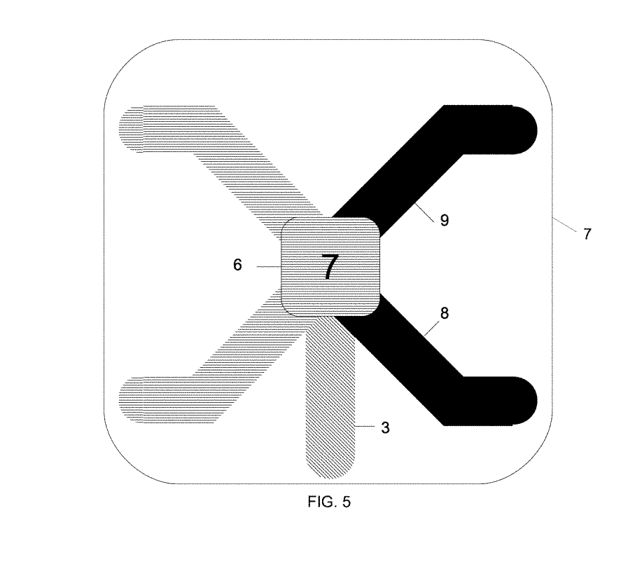

Another example of the same preferred embodiment of a graphical object is illustrated in FIG. 5 in a schematic format. The black graphical elements 8 and 9 are both representing the same geometric object which is the doors between Gallery2 17 and Gallery1 16. These doors are represented by the same link 28 which is black. It is important to clarify that there can be many graphical elements in many graphical objects which represent the same geometric object. However this should not affect the spatial network which is a logical representation of the structure. In this way, the graphical elements communicate the message that both of these doors lead to the same place, and people can choose either.

Both graphical objects 2 and 7, have a textual description which shows the ID of the geometric object on the graphical element in the centre 3 and 6. This design technique further helps people to associate function, id, and description to the geometric object. The ID represents uniquely the node and can help people to start the direction process again from this source node.

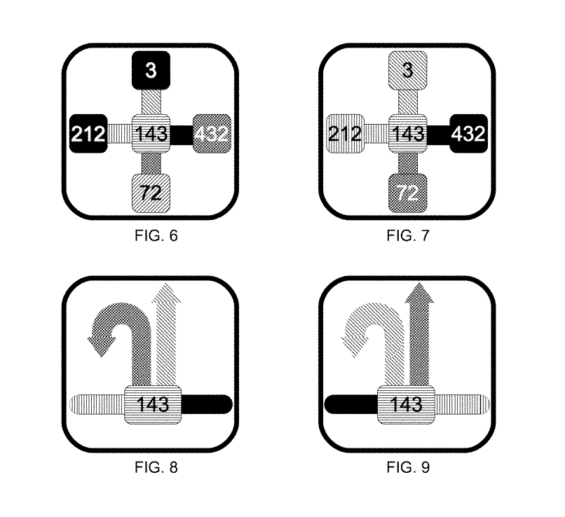

Another example of the same preferred embodiment of a graphical object is illustrated in FIG. 6 in a schematic format. This example demonstrates the fact that a graphical object can include multiple nodes and multiple links.

FIG. 7 illustrates example of the same preferred embodiment of a graphical object, which represents a special case of color-coded networks of the present invention. In these kinds of networks, for every node, all adjacent nodes have different colors. When this is the case, one can decide that between two adjacent nodes there are always two directed links, one inbound and one outbound, and every inbound link of a node has the color of the node. As shown in FIG. 7 when all of these conditions are met, the graphical object can be much more simple, and if decided, there is no need to add graphical elements for the links, and one can use only graphical element for the nodes.

FIG. 8 and FIG. 9 illustrate yet another two examples of the same preferred embodiment of a graphical object. This example demonstrates, how two different graphical objects that are placed in the same room, on two opposite walls, can look very different. This shows again the power of graphic design in communicating visually messages and ideas.

Referring now back to FIG. 1, embodiment of graphical objects, similar to graphical object 2 and graphical object 7, were embedded in every major room on the surface of the floor. People who visit the museum can clearly see these graphical objects, and associate easily between colors and geometric objects.

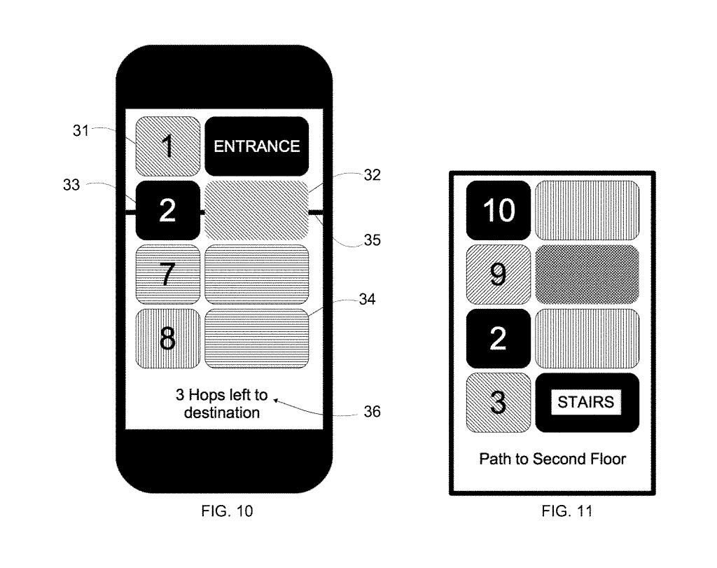

FIG. 10 illustrates one embodiment for displaying a sequence of colors which is a display of a mobile device. Nodes in the display have a square shape, while links have a rectangular shape. The sequence corresponds to a path which starts at the parking 10, and ends in Gallery3 18. The square shape 33 has a black color, which is similar to the assigned color of the respective Node2 23. The rectangular shape 32 has a green color, which is similar to the assigned color of the respective link 26. The sequence start from the top left shape 31 which represents the parking 10, and continues from left to right and top to bottom until it ends on the bottom right shape 34 which correspond to the doors in Gallery3 18. A horizontal line 35 shows the current estimated position of the person, and an indication 36 states the number of nodes it takes to get to the destination node. The sequence includes both links and nodes, however other embodiments may use sequences which only include links, or sequences which only include nodes. Assuming the estimated position is correct, the person is in the main hall 12. The person can verify this by looking at the floor, seeing the middle graphical element 3 in the graphical object 2 which is black, matching it with the color of the next square shape 33 in the sequence which is black as well. The person can further verify it by matching the textual description of the node ID which is visible both on the graphical element 3 and on the display 33. The next shape in the sequence has a rectangular green shape, and hence it is a link. The person then scans the same graphical object 2 and looks for graphical elements around the centre which are green. The structure of the network guarantees that there is no more than one link which is green originating from Node2 23. The person detects the graphical element 3 which is the only green graphical element on the graphical object 2, and walks in the direction which it points to, through passage 5 until the person reaches Gallery2 17, which is represented by Node7 27, which is the other node connected to link 26 which represents the passage 5. The person can then verify again that he got to the right location by matching the blue color of the next shape in the sequence to the color of the graphical element 6 in the centre of the graphical object 7 which is embedded on the floor of Gallery2 17. The person continues this process until the person gets to Gallery3.

There are many methods by which indoor and outdoor mobile devices can estimate their current position. Mobile devices may use their internal sensors, GPS and wireless communication interfaces to constantly update and correct their position. Some of these methods, like GPS for example, are very accurate. However there are many scenarios where the position is not accurate and the mobile device needs more data to improve its estimation. In another embodiment of a graphical object, a wireless beacon is embedded inside it. Because the graphical object is static, and its position is known, the mobile device can use this beacon signal to improve its estimation.

FIG. 11 illustrates another embodiment for displaying a sequence of colors, which is a sequence of colored shapes printed on a paper. The navigation process is exactly as in the previous example, however the person does not have constant feedback of the estimated position. Sequence like this can be printed on brochures to direct people to central locations in the venue, and can be printed using dedicated kiosks.

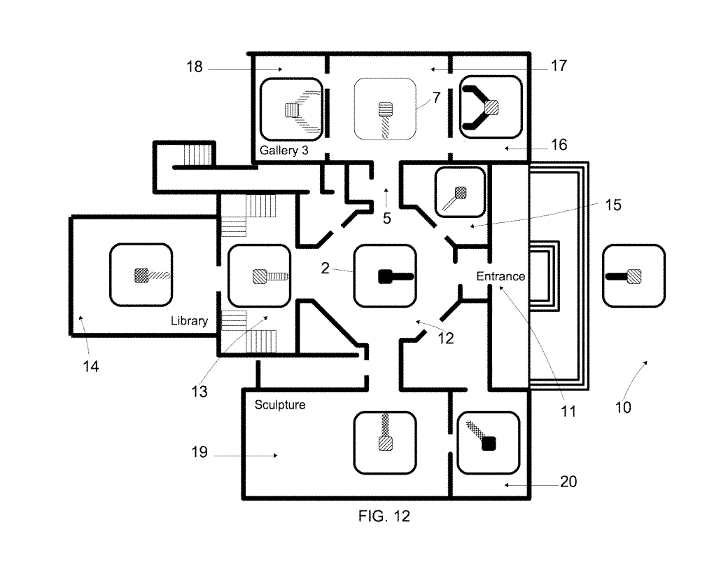

FIG. 12 illustrates the same space as in FIG. 1 where in every major room there is another embodiment of the graphical object embedded on the surface of the floor. Every graphical object further includes illumination elements that are controlled by a central control unit and can highlight graphical elements. FIG. 11 demonstrates an emergency drill where all the people in the museum must exit to the parking. The control unit highlights only the nodes and links that are part of the exit paths. People in every room can see only these links and walk in the direction they point to, until they reach the parking.

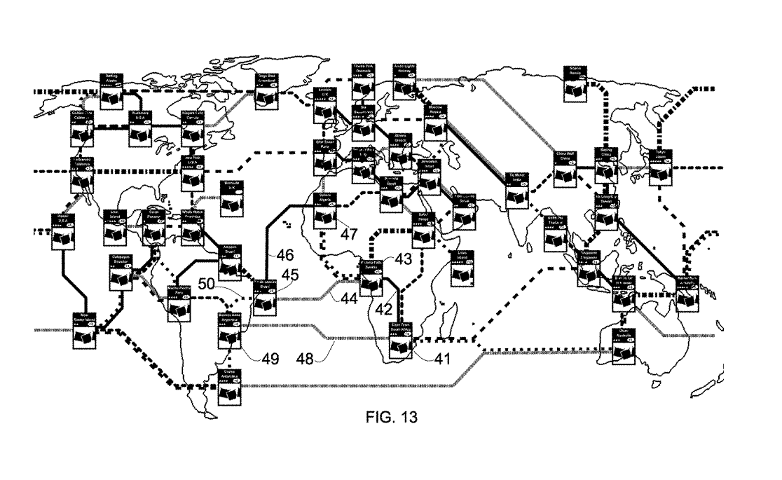

FIG. 13 illustrates in a schematic format the map of the world, which is used in one embodiment of the game of the present invention as a playing space in which the game is played. Those skilled in the art will appreciate that maps of numerous locations, both actual and fictional, such as continents, countries, metropolitan, cities, parks and tourist venues may be depicted while remaining within the scope of the present invention. There are 42 locations in the map, each designated by a playing card image from six different categories and colors. The colors are black, blue, orange, yellow, green and purple and are visually distinct from each other. These locations are situated generally in the same location as they are in the actual map of the world. It will be understood that these are only representative of many of the sites and tourist attraction categories situated within the world, but have been selected as a preferred embodiment of the game as being those most well known by travellers. Transportation routes, designated by a colored line, from the same six different colors, connect the locations and enable traveling between them. The sites and routes form a color-coded spatial network wherein each location is a node in the network, and each route is a link in the network. Some of the links end at one the edge of the map, but continue on the other edge of it, representing the true nature of travelling around the world. All of the links are bidirectional so they are both outbound links and inbound links and enable movement in both ways. However, the game is not limited to only bidirectional links Some nodes have more than one link that connects them. This is fine and allowed and represents more than one travel route between the respective locations.

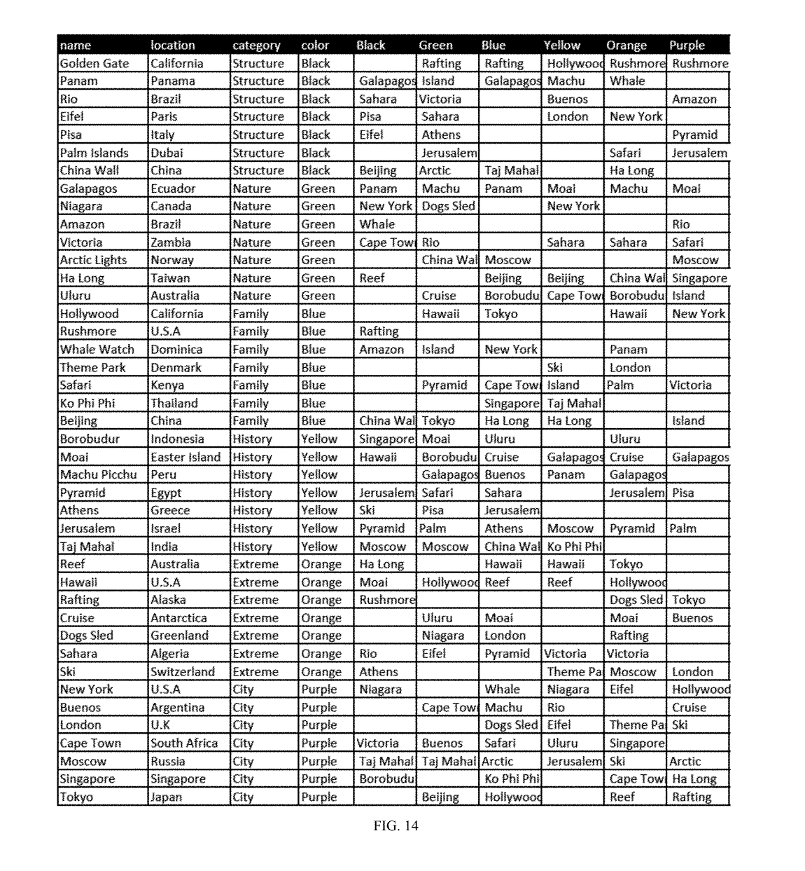

Referring now to the table in FIG. 14 which describes the network transition matrix of the network in FIG. 13. Every node is described by its name, location, category, color and its transition rules. The transition rules specify for each color and node, if there is an outbound link originating from this node, and what is its target node. The matrix answers the requirements that for every node in the network, there is no more than one outbound link with the same color. For example, the node “Cape Town” 41 which is in South Africa belongs to the “City” category, and illustrated by a purple graphical element. The node “Cape Town” 41 has five outbound links: green to “Buenos Aires”, yellow to “Uluru”, orange to “Singapore”, blue to “Safari” and black 42 to “Victoria Falls” 43. The node “Victoria falls” 43 is in Zambia belongs to the “Nature” category, and illustrated by a green graphical element. The node “Victoria falls” has also five outbound links: black 42 to “Cape Town” 41, green 44 to “Rio de Janeiro” 45, yellow and orange to “Sahara” 47 and purple to “Safari”.

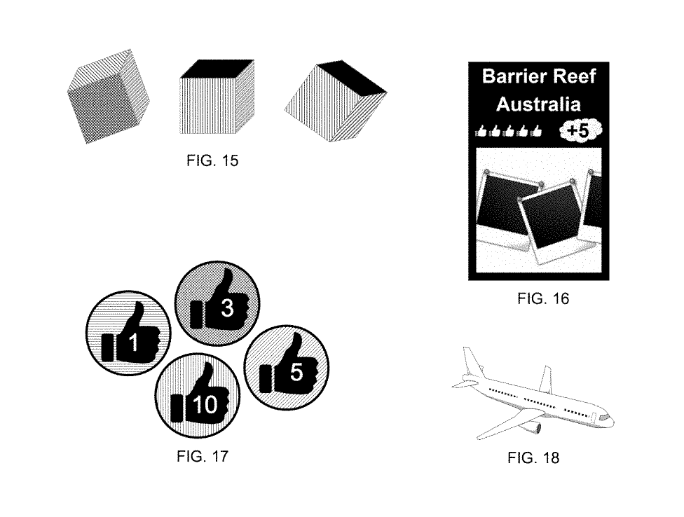

By referring now more particularly to FIG. 15, there is illustrated schematically, three color-coded dice which is the preferred embodiment for generating a sequence of random colors for use by a player to determine the movement that may be made in that player's turn. Each die is a cube, with each of its six sides showing a different color selected from the same color set: black, green, blue, yellow, orange and purple. To move in the playing space, players throw the dice, and then arrange them according to the desired path into a sequence of colors. Another embodiment to generate a sequence of random colors, is a computer software or an electronic device which randomly choose colors from the given set of colors, and display the sequence on a computer display or LED array. Another further embodiment to generate a sequence of random colors, may be a plural of colored spinners, cards or discs.

Referring now back to FIG. 13, the token which represents the player, is now on “Cape Town” 41. The player throws the dice, and the outcome of the dice is black, black, and green. The player inspects the map with the illustrated color-coded network map and search for possible spatial paths originating from “Cape Town” 41 that matches these three colors in any order. The preferred embodiment for the game use only the link colors in the matching process and ignores the node colors. Other variations can use only the node colors, or use both. The player immediately detects that the only possible path that matches these colors is: starting from “Cape Town” 41, travelling to “Victoria Falls” 43 on a black route 42; from there travelling to “Rio de Janeiro” 45 on a green route 44; from there arriving to “Sahara” 47 on a black route 46. The resulted path colors are black, green and black. The player arranges the dice colors in this order, and show the other players that the sequences match. The player then moves his token along this path until the token reaches “Sahara”. If the outcome of the dice was green, yellow and black, the player could have reached “Sahara” through a different path. Starting from “Cape Town” 41, travelling to “Buenos Aires” 49 on a green route 48; from there travelling to “Rio de Janeiro” 45 on a yellow route 50; from there arriving to “Sahara” 47 on a black route 46.

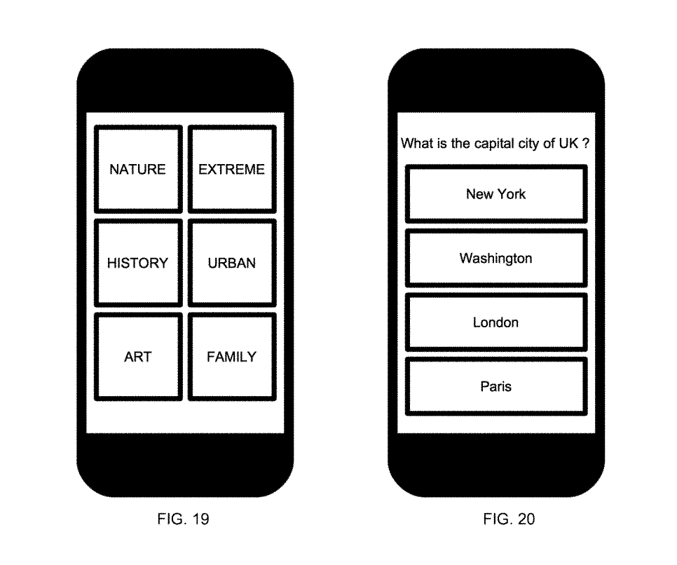

Each player in the game is provided at the beginning of the game with a unique playing token and a plurality of “like” tokens. An embodiment of a playing token is illustrated in FIG. 18. An embodiment of plurality of “likes” tokens is illustrated in FIG. 17. The playing token is associated with the player and can be moved on the map along the color-coded spatial network. The game further includes a software application that randomly selects general knowledge questions relevant to locations in the game. An embodiment of the software is illustrated in FIG. 19 and FIG. 20. Each player, on his turn, uses the three color-colored dice to produce a sequence of random colors. The player then seeks for possible paths along the network which originate from the player's current location and matches this sequence of colors. The number of segments in the path equals to the number of dice in use, so that each link color on the path corresponds to one of the random color generated respectively. If the player finds such a path, he or she travels to the destination the path leads to. If the player can't find a path which matches the outcome colors, the player stays in his place, and waits for the next turn. If there are several alternative paths, the player can decide on which path the player prefers to travel. When the player reaches the new location, he or she can visit it and get the respected location card, earn “likes” by answering a question related to the location, and give a “likes” to other players. An embodiment of a location card is illustrated in FIG. 16. The game is over when all of the locations have been visited. The player with the most accumulated “likes” at the end of the game wins.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

1. A method for directing people in a space comprising the steps of:
defining a space in which the movement take place;
deciding on a spatial network having a plurality of nodes, which represent a first type of geometric objects in said space, and a plurality of links, connecting said nodes, which represent a second type of geometric objects in said space, which allow movement or flow between said first type of geometric objects;
selecting a palette of two or more visually distinct colors;
color-coding said spatial network, assigning a color, from said palette of colors, to each node in said spatial network, assigning a color, from said palette of colors, to each link in said spatial network, wherein nodes can not have more than one outbound link with the same assigned color, and said color-coded spatial network can be described by a color-based network transition matrix;
associating between all said geometric objects and colors, wherein each geometric object is associated with the color of the network element which represents it;
embedding one or more graphical objects on the surface of all said geometric objects wherein said graphical objects are placed in a visible place for people to see,
illustrating one or more graphical elements in each of said graphical objects, wherein each graphical element represents a geometric object, wherein each graphical element is color-coded with the associated color of the geometric object which it represents, wherein the graphic design and position of the graphical element indicate to the people who see the graphical element the relationship between the graphical element and the geometric object which it represents;
deciding on a source geometric object from which the movement start;
generating a sequence of one or more colors from said palette of colors, wherein each color in the sequence corresponds to the color of network elements along a spatial path in order, wherein said spatial path start from a source node which represent said source geometric object, wherein said spatial path respect the direction of links;
displaying, in order, said sequence of colors to the person who makes the movement;
starting the movement process with said source geometric object;
matching the colors between the next color in said sequence of colors to all available colors of the graphical elements which are visible to the person;
identifying the matched graphical element with the similar color, or declaring no match;
moving in said space, toward the geometric object, which is related to said matched graphical element;
continuing this movement process until no more colors are left in said sequence of colors or until there is no match, at which point, restarting or stopping the movement process.

2. The method according to claim 1 wherein: generating a sequence of one or more colors from said palette of colors comprising the steps of:
inputting, in a computer, a source geometric object and a destination geometric object using their description;
querying a database which holds the network transition matrix;
finding the source network element and destination network element which represent the source geometric object and destination geometric object respectively;
calculating a path between said source node and said destination node along said spatial network, wherein said calculation respect the direction of links;
producing a sequence of colors, wherein each color in the sequence corresponds to the color of network elements along said spatial path originating from said source node and ending at said destination node along said network, in order.

3. The method according to claim 1 wherein: illustrating one or more graphical elements in said graphical objects comprising illustrating a graphical element which represents the geometric object on which the graphical object is embedded.

4. The method according to claim 1 wherein: illustrating one or more graphical elements in said graphical objects comprising illustrating graphical elements which represent geometric objects which are represented by network elements which are adjacent to the network element which represent the geometric object on which the graphical object is embedded.

5. The method according to claim 1 wherein: generating a sequence of one or more colors from said palette of colors comprising generating a sequence of a random colors wherein each color is selected randomly from said palette of colors.

6. The method according to claim 1 wherein: displaying a sequence of colors comprising printing a color image with said sequence of colors; giving said image to the person who makes the movement.

7. The method according to claim 1 wherein: displaying a sequence of colors and generating a sequence of one or more colors from said palette of colors comprising the steps of:
throwing one or more color-coded dice, wherein each die side color is selected from said palette of colors;
ordering the outcome color of all said color-coded dice to create a sequence of colors.

8. The method according to claim 1 wherein: displaying a sequence of colors comprising displaying the sequence of colors on a display of a mobile device.

9. The method according to claim 8 further comprising the steps of:
estimating the position of the mobile device in the space throughout the movement;
matching said estimated position with the position of all geometric objects;
detecting the closest geometric object using the metrics which are used in the space;
finding the respective network element in the spatial network which represent said closest geometric object;
using said respective network element as a source node;
displaying visual indications which are related to said network element on said display of a mobile device.

10. The method according to claim 1 wherein: embedding graphical objects on the surface of said geometric objects further comprising the steps of:
embedding one or more illumination elements in said graphical objects wherein each of said illumination elements can highlight graphical elements in said graphical objects;
connecting said illumination elements to a central control unit, wherein said central control unit can turn on and off each of said illumination elements.

11. The method according to claim 1 wherein: embedding graphical objects on the surface of said geometric objects further comprising embedding wireless beacons in said graphical objects; transmitting known signals using said beacons which identify the geometric objects on which the graphical objects are embedded.

12. The method according to claim 1 wherein: the spatial network is an indoor pedestrian network in buildings, airports, hospitals, maritime structures, shopping malls, museums, campuses and venues, the nodes can represent rooms, spaces, halls and elevators, and the links can represent doors, corridors, passages, elevators, stairs, entrances and exits; the spatial network is an outdoor pedestrian network in cities, rural areas, villages, campuses, parks, resorts and venues, the nodes can represent junctions and crossroads, and the links can represent footpaths, trails and crossings; the spatial network is a transportation network which permits vehicular movement, the nodes can represent road junctions, intersections, interchanges, bus, tram and train stations, platforms, airports and seaports, and the links can represent roads, streets, train tracks, bus routes, airlines and ferry routes; the spatial network is a power utility network, the nodes can represent power generation and distribution stations, and the links can represent electricity lines; the spatial network is a water utility network, the nodes can represent water facilities and the links can represent water pipes, aqueducts and covered tunnels; the spatial network is a gas utility network, the nodes can represent gas facilities, and the links can represent gas pipes; the spatial network is a telecommunication network, the nodes can represent routers, switches, hubs, PBX, bridges and telephone exchanges, and the links can represent telephone lines, fibre optics lines and Ethernet cables; the spatial network is a playing space in games, the nodes can represent locations in the playing space, and the links can represents paths in the playing space where tokens can move.

13. A system for wayfinding, the system comprising:
a space in which people move comprising a plurality of a first type of geometric objects, and a plurality of a second type of geometric objects, which allow movement or flow of people between said first type of geometric objects, wherein each geometric object is associated with a color selected from a palette of two or more visually distinct colors; and
a plurality of graphical objects embedded on the surface of said geometric objects, comprising one or more graphical elements, wherein said graphical objects are embedded in a place which is visible to people who move in said space, wherein each graphical element represents a geometric object, wherein each graphical element is color-coded with the associated color of the geometric object which it represents, wherein the graphic design and position of the graphical element indicate to the people who see the graphical element the relationship between the graphical element and the geometric object which it represents; and
a database; and
a mobile device comprising a display, a communication interface, an input interface and a computing unit;
wherein the geometric objects in said space are represented by a color-coded spatial network comprising a plurality of nodes, which represent said first type of geometric objects, and a plurality of links connecting said nodes, which represent said second type of geometric objects, wherein every node and link in said spatial network is color-coded based on the associated color of the geometric object which they represent, wherein nodes can not have more than one outbound link with the same color, wherein the spatial network can be described by a color-based network transition matrix;
wherein said database holds said network transition matrix of said spatial network and allows query operations on it;
wherein said computing unit of said mobile device is configured to connect to said database using said communication interface of said mobile device and query said network transition matrix;
wherein said input interface of said mobile device allows the user to input a source and destination nodes using the description of the geometric objects which the nodes represent;
wherein said computing unit of said mobile device is configured to utilize said source and destination nodes to produce a sequence of colors which corresponds to the assigned color of network elements along a calculated spatial path from said source node to said destination node along said spatial network in order, wherein said path respect the direction of links;
wherein said computing unit of said mobile device is configured to display said sequence of colors to the user on said display of said mobile device.

14. The system according to claim 13 wherein the graphical objects comprising a graphical element which represents the geometric object on which the graphical object is embedded.

15. The system according to claim 13 wherein: the graphical objects comprising graphical elements which represent geometric objects which are represented by network elements which are adjacent to the network element which represents the geometric object on which the graphical object is embedded.

16. The system according to claim 13 further comprising a central control unit, and the graphical objects further comprising illumination elements, wherein said illumination elements can highlight graphical elements in said graphical objects, wherein said illumination elements are connected to said central control unit, wherein said central control unit is capable of turning on and off each of said illumination elements.

17. The system according to claim 16 wherein: the central control unit is configured to highlight a specific plurality of graphical elements in a specific plurality of graphical objects using the illumination elements, wherein said specific plurality of graphical elements represent geometric objects which are part of paths in the space.

18. The system according to claim 13 wherein: the graphical objects further comprising a wireless beacon, wherein said wireless beacon transmits a known signal which identify the geometric object on which the graphical object is embedded, wherein the mobile device is configured to receive a plurality of said signals from a plurality of said wireless beacons.

19. The system according to claim 13 wherein: the computing unit of the mobile device is configured to produce an estimation of the current node, wherein said current node represents the geometric object which is closest to the mobile device, wherein the computing unit of the mobile device can use said current node as the source node when calculating the path, and the computing unit of the mobile device can use said current node to give feedback to the user on the display of the mobile device.

20. The system according to claim 13 wherein: the spatial network is an indoor pedestrian network in buildings, airports, hospitals, maritime structures, shopping malls, museums, campuses and venues, the nodes can represent rooms, spaces, halls and elevators, and the links can represent doors, corridors, passages, elevators, stairs, entrances and exits; the spatial network is an outdoor pedestrian network in cities, rural areas, villages, campuses, parks, resorts and venues, the nodes can represent junctions and crossroads, and the links can represent footpaths, trails and crossings; the spatial network is a transportation network which permits vehicular movement, the nodes can represent road junctions, intersections, interchanges, bus, tram and train stations, platforms, airports and seaports, and the links can represent roads, streets, train tracks, bus routes, airlines and ferry routes; the spatial network is a power utility network, the nodes can represent power generation and distribution stations, and the links can represent electricity lines; the spatial network is a water utility network, the nodes can represent water facilities and the links can represent water pipes, aqueducts and covered tunnels; the spatial network is a gas utility network, the nodes can represent gas facilities, and the links can represent gas pipes; the spatial network is a telecommunication network, the nodes can represent routers, switches, hubs, PBX, bridges and telephone exchanges, and the links can represent telephone lines, fibre optics lines and Ethernet cables.

21. A game, the game comprising:
a plurality of playing tokens which identify separate players in the game; and
a playing space in which the game is played comprising a plurality of a first type of geometric objects, and a plurality of a second type of geometric objects, which allow movement or flow of said playing tokens between said first type of geometric objects, wherein each geometric object is associated with a color selected from a palette of two or more visually distinct colors; and
a plurality of color-coded graphical elements, embedded on the surface of said geometric objects, wherein said plurality of graphical elements are visible to the players, wherein each graphical element represents a geometric object, wherein each graphical element is color-coded with the associated color of the geometric object which it represents, wherein the graphic design and position of the graphical element indicate to the players who see the graphical element the relationship between the graphical element and the geometric object which it represents; and
a means for generating a sequence of random colors, wherein every color in the outcome sequence is randomly selected from said palette of two or more visually distinct colors; and
game rules which determine the goal of the game and the rights and responsibilities of the players;
wherein the geometric objects in said playing space are represented by a color-coded spatial network comprising a plurality of nodes, which represent said first type of geometric objects, and a plurality of links connecting said nodes, which represent said second type of geometric objects, wherein every node and link in said spatial network is color-coded based on the associated color of the geometric object which they represent, wherein nodes can not have more than one outbound link with the same assigned color, wherein the spatial network is described by a color-based network transition matrix;
wherein the outcome color sequence, of said means for a generating a sequence of random colors, determines the movement of said playing tokens in every turn.

22. The game according to claim 21 wherein: the game is a travel game, the playing space is a map of a predetermined geographical area, the spatial network represents a transportation network where nodes represent locations in said map and links represent travel routes between said locations.

23. The game according to claim 22 further comprising a plurality of location cards, a plurality of “like” tokens and a plurality of general knowledge questions, wherein said plurality of location cards are associated with each of said locations, wherein said plurality of general knowledge questions are associated with each of said locations.

24. The game according to claim 21 wherein: the means for generating a sequence of random colors is one or more color-coded dice, wherein each die side color is selected from said palette of two or more visually distinct colors, wherein the players can arrange said outcome color of said color-coded dice into a sequence of color.
